(19) United States
(12) Patent Application Publication
(10) Pub. No.: US 2024/0184041 A1
(43) Pub. Date: Jun. 6, 2024

(54) Laser Ultrastable Photonics with Integrated Nonlinearity for Extended Stability

(71) Applicants: The Regents of the University of California, Oakland, CA (US); The United States Government, as represented by the Secretary of Commerce, Gaithersburg, MD (US)

(72) Inventors: Daniel J. Blumenthal, Santa Barbara, CA (US); Scott Papp, Gaithersburg, MD (US)

(73) Assignees: The Regents of the University of California, Oakland, CA (US); The United States Government, as represented by the Secretary of Commerce, Gaithersburg, MD (US)

(21) Appl. No.: 18/527,017

(22) Filed: Dec. 1, 2023

Related U.S. Application Data
(60) Provisional application No. 63/429,474, filed on Dec. 1, 2022.

(51) Int. Cl. G02B 6/122; G02B 6/12

(52) U.S. Cl. CPC G02B 6/1225; G02B 6/12004; G02B 2006/12054; G02B 2006/12061; G02B 2006/12142

(57) ABSTRACT

Optical photonic integrated optical clocks on photonic integrated circuits are described. The optical clocks can provide the timing stability of atomic clocks at ultra-low size and power. The optical clocks are be fabricated using CMOS foundry fabrication processes.

### CROSS-REFERENCE TO RELATED APPLICATIONS

The current application claims the benefit of U.S. Provisional Patent Application No. 63/429,474 entitled “Laser Ultrastable Photonics with Integrated Nonlinearity for Extended Stability” filed Dec. 1, 2022. The disclosure of U.S. Provisional Patent Application No. 63/429,474 is hereby incorporated by reference in its entirety for all purposes.

### FIELD OF THE INVENTION

The current disclosure is directed to systems and methods for photonic integrated optical frequency comb stabilization; and more particularly to systems and methods for all-optical photonic integrated optical clocks.

### BACKGROUND OF THE INVENTION

As lasers exhibit various types of laser noise, instabilities, and long-term drift, which can be undesirable in applications, suppressing noise and stabilizing certain laser parameters using various techniques may be needed. Stabilized lasers can have improved stability in terms of output power, frequency noise (FN), relative intensity noise (RIN), optical carrier frequency, or other quantities.

### BRIEF SUMMARY

Systems and methods in accordance with various embodiments provide all-optical photonic integrated optical clocks and optical frequency stabilization that have the timing stability of certain atomic clocks at ultra-low size and power. Several embodiments use laser stabilization to generate a microwave carrier from resonators including (but not limited to) an ultrahigh quality factor (Q) photonic integrated resonator and optical frequency combs and optical nonlinearities such as second harmonic generation (SHG). Certain embodiments implement the stability of optical modes in a photonic resonator combined with an SHG laser and optical frequency comb stabilization approach. Various embodiments combine quantum-based nonlinear frequency combs and scalable integrated photonic and electronic technologies with resonators and optical nonlinearities. Several embodiments employ common mode noise cancellation in a common reference cavity, for example using nonlinear optics like SHG, or multi-spatial modes, to lock two or more optical signals to a common cavity and subtract common cavity noise like thermorefractive noise (TRN). Many embodiments implement chip-scale integration that can reduce size and weight, lower power consumption, improve controllability and reliability, and/or improve repeatability and manufacturability. These advantages can be important to applications from atomic, to quantum, to communications, and metrology. Several embodiments provide that larger numbers of stabilized lasers can be used in applications that may need large numbers of lasers, for example quantum computing and realizing small, light-weight versions for applications such as space-based applications.

Some embodiments include an optical clock comprising: a first photonic chip comprising a laser source; a second photonic chip comprising a microcomb photonic integrated circuit (PIC) and a second harmonic generation, wherein the second chip is connected with the first chip via a first photonic wire bond; a third photonic chip comprising an optical reference PIC that supports at least two modes generated from the second photonic chip, wherein the third chip is connected with the second chip via a second photonic wire bond; and a fourth photonic chip comprising a PIC and an electronic circuitry to stabilize a plurality of components on the first, second and third photonic chips and generate a stable reference signal, wherein the fourth chip is connected with the third chip via a third photonic wire bond; wherein the optical clock stabilizes two different wavelengths from 405 nm to 2350 nm to a desired optical frequency.

In some embodiments, the microcomb PIC comprises a photonic-crystal resonator microcomb.

In some embodiments, the photonic-crystal resonator microcomb comprises tantalum pentoxide and lithium niobate.

In some embodiments, the photonic-crystal resonator microcomb integrates a thin film lithium niobate with a low-loss tantalum pentoxide waveguide.

In some embodiments, the lithium niobate has a structure of periodically poled lithium niobate.

In some embodiments, the optical reference PIC comprises a stress-optic modulator comprising an actuator and a ring resonator.

In some embodiments, the actuator is laterally and vertically offset from a core of the ring resonator and from an optical mode profile of the ring resonator such that the actuator does not appreciably affect a waveguide loss or a resonator quality factor (Q).

In some embodiments, the core of the ring resonator comprises a material selected from the group consisting of: silicon nitride, tantalum pentoxide, alumina oxide, and aluminum nitride.

In some embodiments, the actuator comprises lead zirconate titanate (PZT) and the ring resonator comprises silicon nitride, and the modulator functions at a wavelength selected from the group consisting of: a visible wavelength range from 400 nm to 750 nm, a near IR wavelength range from 700 nm to 2500 nm, and a mid IR wavelength range from 2500 nm to 25,000 nm.

In some embodiments, the actuator comprises PZT and the ring resonator comprises tantalum pentoxide, alumina oxide, or aluminum nitride, and the modulator functions at a wavelength range selected from the group consisting of: a far-UV wavelength range from 100 nm to 200 nm, a mid-UV wavelength range from 200 nm to 300 nm, a near UV wavelength range from 300 nm to 400 nm, and a visible, near IR and mid-IR wavelength range from 400 nm to 2350 nm.

In some embodiments, the laser source comprises a semiconductor laser.

In some embodiments, the semiconductor laser is an indium phosphide distributed-feedback laser.

In some embodiments, the two different wavelengths are 780 nm and 1560 nm.

In some embodiments, the first, second, third, and fourth photonic chips are deposited on a same substrate.

In some embodiments, the optical clock is compatible with CMOS foundry fabrication process.

Additional embodiments and features are set forth in part in the description that follows, and in part will become apparent to those skilled in the art upon examination of the specification or may be learned by the practice of the disclosed subject matter. A further understanding of the nature and advantages of the present disclosure may be realized by reference to the remaining portions of the specification and the drawings, which form part of this disclosure.

### BRIEF DESCRIPTION OF THE DRAWINGS

The description will be more fully understood with reference to the following figures, which are presented as exemplary embodiments of the invention and should not be construed as a complete recitation of the scope of the invention. It should be noted that the patent or application file contains at least one drawing executed in color. Copies of this patent or patent application publication with color drawing(s) will be provided by the Office upon request and payment of the necessary fee.

FIG. 1 illustrates a schematic of the clock architecture in accordance with an embodiment of the invention.

FIG. 2A illustrates a bulk-optic microwave clock generation from an optical reference resonator in accordance with prior art.

FIG. 2B illustrates microwave clock generation from a bulk-optic SH laser spectroscopy of a reference resonator in accordance with prior art.

FIG. 3 illustrates a correlation between the 780 nm and 1560 nm wavelengths in accordance with an embodiment of the invention.

FIG. 4 illustrates measured microcromb spectrum of dark soliton microcombs in photonic crystal resonator in accordance with prior art.

FIG. 5 illustrates an optical reference resonator PIC in accordance with an embodiment of the invention.

FIGS. 6A and 6B illustrate characteristics of a stress-optic modulator in accordance with prior art.

### DETAILED DESCRIPTION

Systems and methods for implementing laser ultra-stable photonics with integrated nonlinearity for extended stability frequency references and clocks in accordance with embodiments are described. In many embodiments, these clocks and frequency references can provide microsecond timing stability over a week or longer, or nanosecond stability over a week or longer. Depending on the design choices, physics, integration technologies, and cost, the fractional stability and time scale can be different. Integration offers these timing and stability capabilities at low size and power, e.g. cubic centimeters volume operating at less than a Watt power consumption. using, for example, laser stabilization to generate a microwave carrier from an ultrahigh Q photonic resonator. Using the inherent stability of optical modes (e.g. spatial, frequency, polarization) combined with an optical nonlinearity such as SHG, laser stabilization approach, the integrated clock in accordance with some embodiments can achieve desired timing performance across the size, weight, and power (SWaP) and environment metrics for (but not limited to) atomic and quantum applications and other applications which utilize frequency references. Several embodiments combine quantum-based nonlinear frequency combs and scalable integrated-photonics/electronics technologies. Other optical nonlinearities can also be employed including optical parametric oscillation (OPO) and four wave mixing (FWM).

In many embodiments, the integrated clock combines one or more of the following features:
1) Ultrahigh Q optical reference resonator with integrated PZT frequency and phase modulation;
2) Heterogeneously integrated photonic-crystal resonator microcombs or photonic molecule multi-resonators and lithium niobate SHG;
3) Architecture for microwave generation traceable to ultra-stable, integrated lasers.

Many embodiments implement second harmonic generation (SHG) to enable stabilization. Second harmonic (SH) stabilization can reduce environmental sensitivity of the optical reference resonator free-spectral range (v_{FSR}). Examples include locking two optical fields (modes), which have an exact 2× frequency relation, to two modes of the same optical resonator. Several embodiments derive the microwave clock output by stabilizing the repetition frequency (fᵣₑₚ) of a microresonator comb to the reference resonator free spectral range (FSR). The mode structure of the optical reference resonator can be:

vₘ=cm/2πn(T)R=v_{FSR}m

where m is the mode number, c is the speed of light, R is the resonator radius, and n(T) is the temperature (T) dependent refractive index. Some embodiments implement the Allan deviation relationship of the reference δ(v_{FSR})/v_{FSR}=δ(vₘ)/vₘ, hence the fractional frequency stability of the FSR is lower bounded by the optical frequency stability. SH stabilization in accordance with certain embodiments can improve the optical mode stability of the resonator, according to servo control of temperature via 2vₘ (T)=vₘ′ (T) where the mode m is at about 1560 nm and m′ is at about 780 nm or 2× frequency. Photonic design of the reference resonator in accordance with some embodiments enables optimized mode overlap at about 1560 nm and about 780 nm. Many embodiments take advantage of the strong, temperature-immune correlations induced with SH stabilization by using a microcomb bandwidth and low-noise properties such that the stabilized phase noise of fᵣₑₚ, S_{frep}=Sᵥ_{_{FSR}}+(Sᵥ_{ₚᵤₘₚ}+Sᵥ_{ₙ})/n² where n counts the mode number of the comb stabilized to the optical reference with respect to the pump laser, sufficient to meet the timing metrics of many applications.

Several embodiments leverage robust environmental mitigation concepts from microwave and mechanical oscillators, and implement them with quantum-limited optical processes including (but not limited to) SHG. Several embodiments provide ultra-efficient technologies including (but not limited to) indium phosphide lasers, photonic-wire bonding, integrated lithium niobate for SHG, integrated lead zirconate titanate (PZT) modulators, and integrated electronic readout. Many embodiments include various subsystems including (but not limited to) a semiconductor laser, an integrated microcomb with integrated periodically poled lithium niobate (PPLN, SHG material), the optical reference resonator with integrated PZT phase modulators and resonator frequency shifter or equivalent and integrated electronics and photonics to implement laser stabilization loops and 100 MHz output clock generation. In many embodiments, the optical clock can stabilize two different wavelengths ranging from invisible to infrared (from about 405 nm to about 2350 nm) to a desired wavelength.

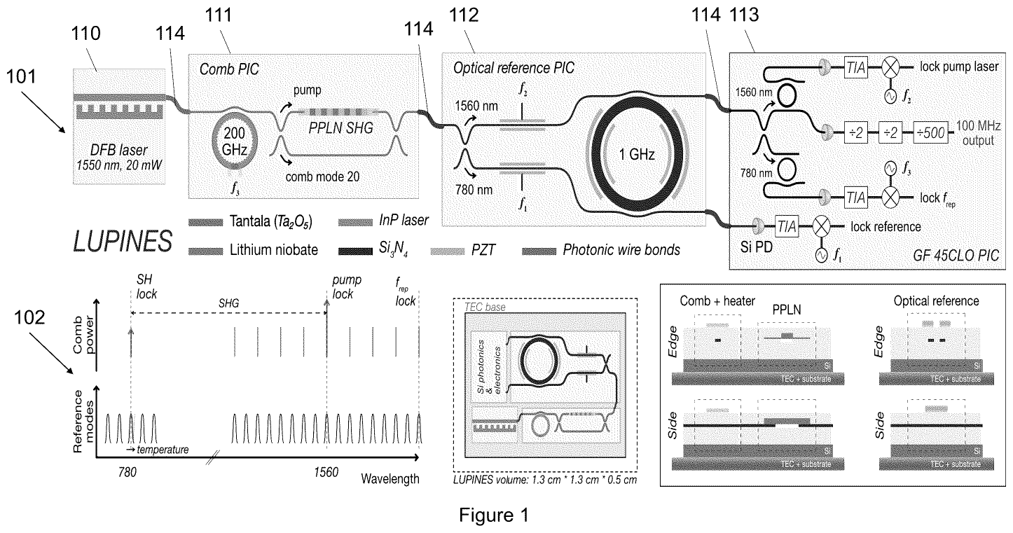

FIG. 1 illustrates a clock or frequency reference architecture in accordance with an embodiment of the invention. 101 shows the four photonic chips and their optical interconnections. The optical clock or frequency reference can include a first photonic chip 110. The first photonic chip can include a laser source. The laser can be a semiconductor laser. Examples of semiconductor lasers include (but are not limited to) gallium arsenide (GaAs) lasers, aluminum gallium arsenide (AlGaAs) lasers, gallium phosphide (GaP) lasers, indium gallium phosphide (InGaP) lasers, gallium nitride (GaN) lasers, indium gallium arsenide (InGaAs) lasers, indium gallium arsenide nitride (GalnNAs) lasers, indium phosphide (InP) lasers, and gallium indium phosphide (GalnP) lasers. The semiconductor laser can be an InP distributed-feedback (DFB) laser of about 1550 nm wavelength and provide about 20 mW on-chip power.

The first photonic chip 110, a pump laser, is in photonic connection with a second photonic chip 111 via such as (but not limited to) a photonic wire bond 114. The second photonic chip 111 can include a microcomb photonic integrated circuit (PIC) that generates a signal at a repetition frequency, e.g. 200 GHz, and a second harmonic generator (SHG) and other passive combining and splitting elements to output the desired comb mode (e.g. 1560 nm) and the second harmonic version of the comb mode (e.g., 780 nm. The microcomb PIC can include an optical-frequency comb such as a photonic-crystal resonator microcomb. The photonic-crystal resonator microcomb can comprise tantalum pentoxide (or tantala) and PPLN. The photonic-crystal resonator microcombs may enable efficient creation of frequency combs with mode spacing in the range from about 40 GHz to about 1000 GHz, utilizing a 1550 nm pump-laser source. The microcombs can operate in a bright soliton or dark soliton modality. Several embodiments integrate thin-film lithium niobite (or PPLN) with low-loss tantala waveguides. Building on the integration of lithium niobate-on-tantala for visible wavelengths, several embodiments extend the spectral coverage to enable ultra-efficient frequency doubling from 1560 nm to 780 nm.

The second photonic chip 111 is in photonic connection with a third photonic chip 112 via such as (but not limited to) a photonic wire bond 114. The third photonic chip 112 can include an optical reference PIC, for example a dual-mode waveguide resonator, which operates at both the primary (e.g., 1560 nm) and second harmonic (e.g., 780 nm) frequencies. The reference resonator can incorporate integrated frequency tuning and PZT stress-optic phase modulation on the same chip. The resonator in accordance with certain embodiments can be a 1 GHZ FSR dual-bus design that supports the 1560 nm and the 780 nm modes. The reference FSR can be tuned for precision locking to the 1560 nm and 780 nm wavelengths, using thermal and PZT tuning. Once locked, the resonator can be used to stabilize the repetition rate of the optical frequency comb. The modes are designed with maximum optical mode overlap in order to maximally cancel out common mode noise. Common mode thermo-refractive noise (TRN) and photothermal noise (PT) can be cancelled. The 780 nm and 1560 nm wavelengths can be split to separate waveguides, phase modulated (PM) using the ultra-low loss and ultra-low power (20 nW) PZT, and coherently coupled to the reference resonator. This resonator spectroscopy enables to generate locking error signals and feedback that controls and mitigates noise of the FSR.

In many embodiments, laser tuning can be achieved by stress-optical and thermal tuning of the laser wavelength or optical frequency comb to lock it to the reference cavity. Several embodiments implement stress-optic modulators in the stabilized clock or optical frequency reference. Stress-optic modulators can comprise actuators and resonators. The actuators can be piezo-electric actuators. The resonators can be ring resonators or phase resonators. The actuators can comprise piezo-electric materials such as (but not limited to) PZT or aluminum nitride. The ring resonators have a core that can be made of materials such as silicon nitride, tantalum pentoxide (or tantala), alumina oxide or aluminum nitride. Materials such as tantalum pentoxide, alumina oxide or aluminum nitride can achieve a wide band gap modulation where the modulators function at a far-UV range from about 100 nm to about 200 nm, a mid-UV range from about 200 nm to about 300 nm, a near UV range from about 300 nm to about 400 nm, and visible, near IR and mid-IR ranges from about 400 nm to about 2350 nm, and beyond. Modulators with silicon nitride resonators can achieve modulation at a wavelength of a visible wavelength range from about 400 nm to about 750 nm, a near IR wavelength range from about 700 nm to about 2500 nm, and a mid IR wavelength from about 2500 nm to about 25,000 nm.

In certain embodiments, the stress-optic modulators comprise circular piezo-electric actuators and ring resonators. The piezo-electric actuators can be offset from the ring resonators such that a first circular portion of the circular piezo-electric actuator is located on the outside of the ring resonators and a second circular portion of the circular piezo-electric actuator is located on the inside of the ring resonator. The circular piezo-electric actuators can be separated from the ring resonators by a top cladding layer. The circular piezo-electric actuators can change the guiding properties of the ring resonators based on the voltage applied to the circular piezo-electric actuators by inducing strain through the top cladding layer to change the optical properties of the ring resonators.

Various types of reference cavity such as (but not limited to) coil reference cavity and/or ultra-high Q (UHQ) waveguide reference cavity (Q of at least 40 million; of at least 50 million; or of at least 60 million; or of at least 70 million), can be integrated in the laser stabilization circuit. Examples of coil reference cavity include (but not limited to) 2-meter on-chip coil resonator, 4-meter on-chip coil resonator, 6-meter on-chip coil resonator, 8-meter on-chip coil resonator, 10-meter on-chip coil resonator. Such coil reference cavity has a large volume to suppress thermal fluctuations. (See, e.g., U.S. patent application Ser. No. 18/488,860 filed Oct. 17, 2023; the disclosure of which is hereby incorporated by reference.) The stabilization scheme can for example achieve over 4 orders of magnitude frequency noise reduction from about 10 Hz to about 1 kHz, 4.5 times reduction in the 1/π integral linewidth to about 712 Hz, and close to thermo-refractive noise (TRN) limited performance. The ultra-low power stress-optic modulator and ring-resonator reference cavity can use the same ultra-low loss Si₃N₄ waveguide platform. Si₃N₄ has advantages such as low loss across optical transparency window from visible wavelengths of about 400 nm to telecom wavelengths of about 1550 nm; compatible with CMOS foundry fabrication processes; and compatible with high power. The fabrication processes of the integrated stabilized laser, the modulator, and the ring-resonator are compatible with CMOS foundry processes. The PZT stress-optic modulator has a DC to 15 MHz 3-dB modulation bandwidth, a low optical loss of about 0.03 dB/cm at 1550 nm (or a loss of about 0.3 dB/cm at 780 nm; or a loss of about 0.6 dB/cm at 674 nm; or a loss of about 9 dB/cm at about 461 nm), and ultra-low power consumption of about 20 nW. (See, e.g., U.S. patent application Ser. No. 18/485,173 filed Oct. 11, 2023; the disclosure of which is hereby incorporated by reference.)

The third photonic chip 112 is in photonic connection with a fourth photonic chip 113 via such as (but not limited to) a photonic wire bond 114. The fourth photonic chip 113 can include a PIC comprising photodetectors that can measure the stabilized output as well as necessary trans impedance amplifiers (TIAs) to maximize the signal to noise ratio (SNR) and minimize distortion. The detectors are selected to receive the light at, for example, the fundamental 1560 nm and SH 780 nm wavelengths. Electrical circuitry is provided to lock the pump laser at f2 and to divide the signal to a usable output, for example 100 MHz and to lock the repetition rate using the second harmonic to for example a frequency f3. A third lock circuit can be used to lock the reference cavity to a signal f1.

102 shows the SH and comb stabilization approach and integration details. The panel in 102 shows the relationship between the SH lock, pump lock and frequency lock as well as the SHG relation between the pump and SHG optical signals. Examples of integration of the comb and heater and optical reference are shown in the bottom right panel of FIG. 1. Through ultraprecise laser stabilization, the 200 GHz repetition frequency of a microresonator frequency comb can attain the stability of a pristine, ultrahigh-Q, integrated reference resonator. Optical-frequency drift from the environment of the reference resonator may be suppressed through an SH stabilization approach in accordance with many embodiments. In some embodiments, the frequency difference of 780 nm and 1560 nm modes can be stabilized to the exact span of an SH laser using the SH stabilization approach, where the relationship between 1560 nm and its second harmonic 780 nm are exact and perfect (except for quantum noise).

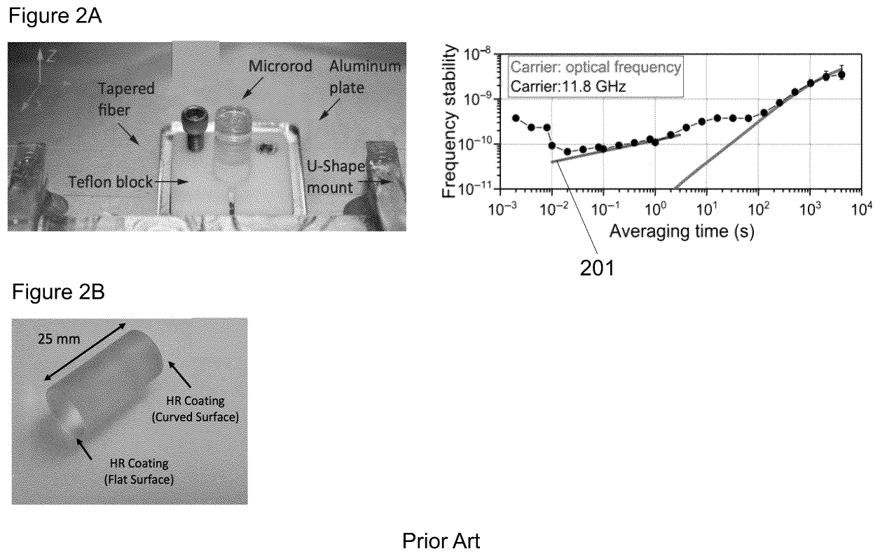

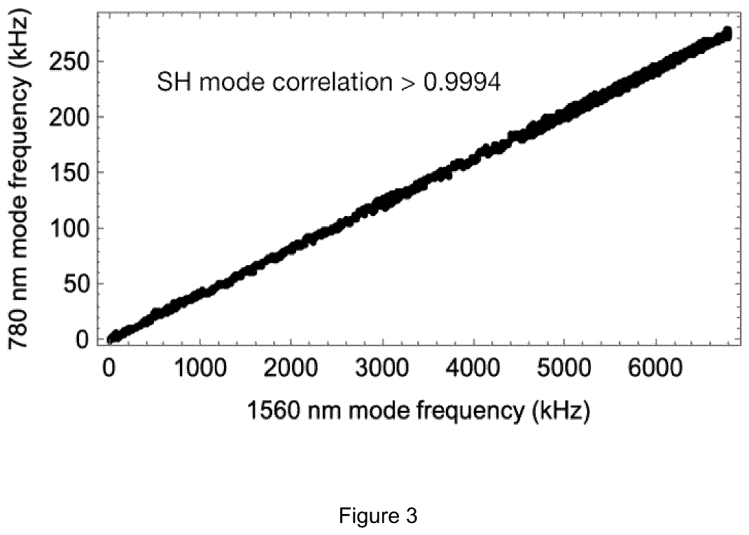

Several embodiments provide ultraprecise comb stabilization to the FSR of a resonator and the SH stabilization technique to directly measure relative fluctuations of 1560 nm and 780 nm resonator modes. FIG. 2A illustrates a bulk-optic (non-integrated) microwave clock generation from an optical reference resonator. FIG. 2B illustrates microwave clock generation from a bulk-optic SH laser spectroscopy of a reference resonator. The microwave frequency stability can be attained by locking fᵣₑₚ to the FSR. The current experimental limit (201 in FIG. 2A) is from comb a bandwidth of about 800 GHz. The clock in accordance with many embodiments may be able to use microcombs with more than 10 THz bandwidth. SH laser spectroscopy shown in FIG. 3 show a strong correlation (greater than about 99.94%) amongst the 780 nm and 1560 nm, suggesting that it would be possible to reduce temperature-induced fractional-frequency drift in the optical reference resonators from about 10-11/s to about 10-15/s. Along with frequency noise reduction in fᵣₑₚ stabilization, SH stabilization in accordance with many embodiments can enable precision atomic and quantum clock and other application stability.

### Microcomb

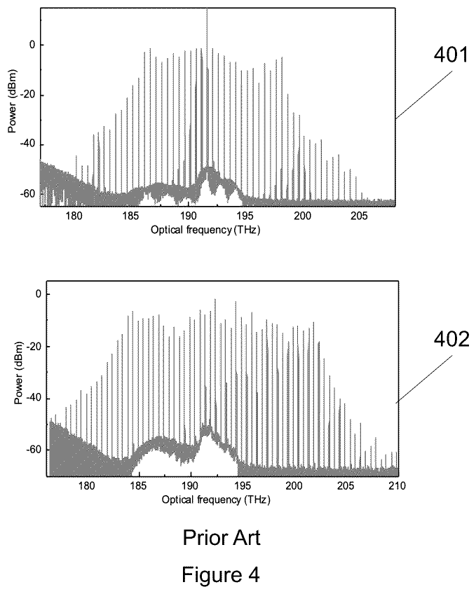

Many embodiments use photonic-crystal resonator (PhCR) microcombs in the clocks. PhCR microcombs may enable efficient creation of frequency combs with mode spacing in the range from about 40 GHz to about 1000 GHZ, utilizing a 1550 nm pump-laser source. PhCR microcombs can operate in a bright soliton or dark soliton modality, offering detailed comb spectrum designs to suit applications in accordance with some embodiments. FIG. 4 illustrates measured microcromb spectrum of dark soliton microcombs in PhCRs. 401 shows dark soliton microcombs with an on-chip reflector. 402 shows dark soliton microcombs with an on-chip build-up cavity to enhance power in the PhCR. These microcombs demonstrate greater than about 50% conversion efficiency and conversion efficiency as high as 90% and higher. Since microcomb generation in the PhCR may depend only on fundamental characteristics of the PhCR, some embodiments perform detailed design and modeling of the comb. Some embodiments implement PhCR microcombs with about 10 THz bandwidth and about 200 GHZ fᵣₑₚ that operate with about 20 mW on-chip power. Some embodiments provide optimization of the microcomb PIC for ultrastable laser stabilization. In some embodiments, designs for other characteristics (design choice) to meet other bandwidth, repetition rate and on-chip power requirements, can be implemented.

### Optical Reference Resonator Photonic Integrated Circuit

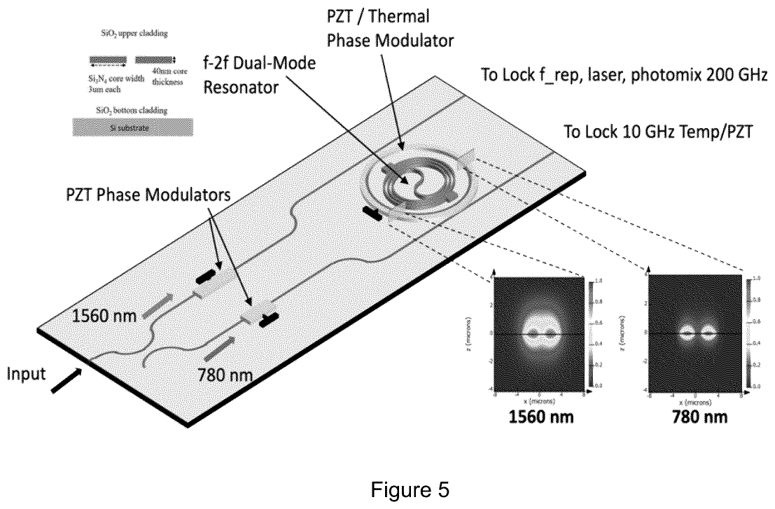

Several embodiments provide realizations of ultra-high Q photonic frequency discriminating reference PIC implemented in the ultra-low loss silicon nitride integration platform. The reference resonator can incorporate integrated frequency tuning and PZT stress-optic phase modulation on the same chip. The resonator in accordance with certain embodiments can be a 1 GHz FSR dual-bus design that supports both the 1560 nm and the 780 nm modes as illustrated in FIG. 5. As can be readily appreciated, any of a free spectral range dual-bus design for various wavelength modes can be utilized as appropriate to the requirements of specific applications in accordance with various embodiments of the invention. The reference FSR can be tuned for precision locking to the 1560 nm and 780 nm light, using thermal and PZT tuning. Once locked, the resonator can be used to stabilize the repetition rate of the optical frequency comb. The modes are designed with maximum optical mode overlap and common mode thermo-refractive noise (TRN) and photothermal noise (PT) can be cancelled. The 780 nm and 1560 nm wavelengths can be split to separate waveguides, phase modulated (PM) using the ultra-low loss and ultra-low power (20 nW) PZT, and coherently coupled to the reference resonator. This resonator spectroscopy enables to generate locking error signals and feedback that controls and mitigates noise of the FSR.

FIG. 5 illustrates an optical reference resonator PIC in accordance with an embodiment of the invention. Waveguide resonator design can support 1560 nm and 780 nm with optimized mode overlap. Integrated PZT modulators are for sideband modulation and locking of reference cavity to 1560 nm and 780 nm from SH laser and comb.

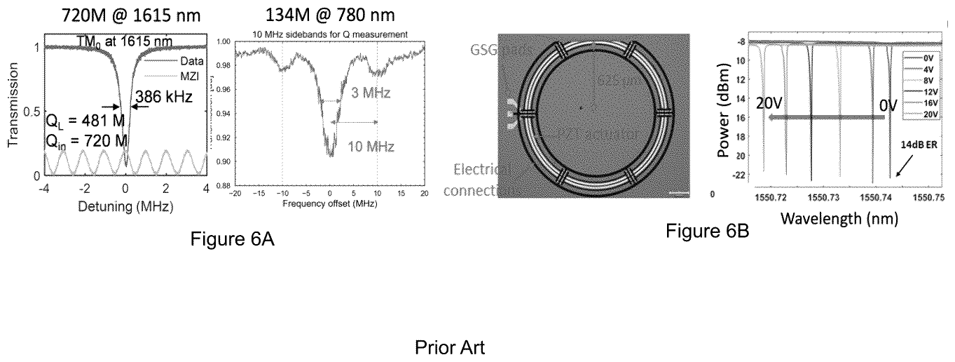

FIG. 6A shows ultra-high 720 million Q and ultra-low 0.034 dB/m loss at 1550 nm. The visible wavelength design in accordance with some embodiments can achieve ultra-low about 0.4 dB/m loss and about 130 million Q at 780 nm. In several embodiments, the Q can be increased towards about 1 billion at 1550 nm and several hundred million at 780 nm. Many embodiments implement waveguide geometries that can maximize the modal overlap. An ultra-low power (20 nW) stress-optic PZT modulator can be integrated in the silicon nitride platform, as shown in FIG. 6B. The modulator delivers DC to 30 MHz bandwidth without reduction of the waveguide optical loss and achieves a constant Q and extinction ratio over the 4 GHz tuning range.

In some embodiments, resonator designs can include a 1 GHz FSR with an octave spanning waveguide design that supports both 1560 nm and 780 nm with maximum mode overlap. In certain embodiments, a twin waveguide core design is shown in FIG. 5. In FIG. 5, the upper cladding is about 6 μm, lower cladding is about 15 μm, and twin waveguides dimensions of about 40 nm×3 μm each with about 1 μm gap between. This design yields an effective mode area of about 11 mm² at 780 nm and an effective area of about 31 mm² at 1550 nm, yielding a mode overlap of 55%.

### Chip Interconnects: Pump Laser and Photonic Wire Bond Integration

In many embodiments, the III-V InP laser, tantala optical frequency comb and lithium niobate (PPLN) SHG, optical reference resonator PIC, and the silicon photonics/electronics chip can be mounted on a common substrate and electrically and optically interconnected. The III/V laser chip can provide about 20 mW on-chip power for the microcomb, consuming about 75 mW of electrical power at about 1 dB insertion loss and about 33% wall plug efficiency. The chips can be optically interconnected using various techniques, or can be integrated onto common chips with a subset of the chips integrated on one or more chips. Many application areas for integrated photonic circuits place extremely high demands on optical component performance. While these individual components exist, monolithic approaches can often degrade device level performance. Hybrid integration can overcome some of these limitations, but with additional drawbacks such as increased coupling losses, and tight fabrication and packaging tolerances needed to make hybrid integration successful.

### Second Harmonic Generation Integrated on the Microcomb Chip

In many embodiments, generating the SH laser relies on heterogeneous integration of thin-film lithium niobate with low-loss tantala waveguides. Building on the development of lithium niobate-on-tantala for visible wavelengths, several embodiments extend the spectral coverage to enable ultra-efficient frequency doubling from 1560 nm to 780 nm. Recent demonstrations have shown SH conversion efficiencies in comparable thin-film lithium niobate structures to be as high as 30,000%/W-cm² at wavelengths across the visible and near-IR. Adapted for the invention in accordance with certain embodiments, greater than about 10 μW of optical power can be generated at expected fundamental input powers, which may be sufficient for high-SNR detection and locking of the optical reference. The SH section of the comb PIC can be fabricated in a scalable process by die-bonding a small piece of about 300 nm thickness lithium niobate-on-insulator wafer directly onto the patterned tantala wafer. The handle wafer can then be chemically removed, electrodes for periodic poling deposited, and an engineered voltage pulse applied to initiate crystal domain inversion of the LN. After poling, the electrodes can be removed, and the LN patterned via electron-beam lithography and Ar-ion etching.

### DOCTRINE OF EQUIVALENTS

As can be inferred from the above discussion, the above-mentioned concepts can be implemented in a variety of arrangements in accordance with embodiments of the invention. Accordingly, although the present invention has been described in certain specific aspects, many additional modifications and variations would be apparent to those skilled in the art. It is therefore to be understood that the present invention may be practiced otherwise than specifically described. Thus, embodiments of the present invention should be considered in all respects as illustrative and not restrictive.

As used herein, the singular terms “a,” “an,” and “the” may include plural referents unless the context clearly dictates otherwise. Reference to an object in the singular is not intended to mean “one and only one” unless explicitly so stated, but rather “one or more.”

As used herein, the terms “approximately,” and “about” are used to describe and account for small variations. When used in conjunction with an event or circumstance, the terms can refer to instances in which the event or circumstance occurs precisely as well as instances in which the event or circumstance occurs to a close approximation. When used in conjunction with a numerical value, the terms can refer to a range of variation of less than or equal to ±10% of that numerical value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%.

Additionally, amounts, ratios, and other numerical values may sometimes be presented herein in a range format. It is to be understood that such range format is used for convenience and brevity and should be understood flexibly to include numerical values explicitly specified as limits of a range, but also to include all individual numerical values or sub-ranges encompassed within that range as if each numerical value and sub-range is explicitly specified. For example, a ratio in the range of about 1 to about 200 should be understood to include the explicitly recited limits of about 1 and about 200, but also to include individual ratios such as about 2, about 3, and about 4, and sub-ranges such as about 10 to about 50, about 20 to about 100, and so forth.

What is claimed is:

1. An optical clock comprising:
a first photonic chip comprising a laser source;
a second photonic chip comprising a microcomb photonic integrated circuit (PIC) and a second harmonic generation, wherein the second chip is connected with the first chip via a first photonic wire bond;
a third photonic chip comprising an optical reference PIC that supports at least two modes generated from the second photonic chip, wherein the third chip is connected with the second chip via a second photonic wire bond; and
a fourth photonic chip comprising a PIC and an electronic circuitry to stabilize a plurality of components on the first, second and third photonic chips and generate a stable reference signal, wherein the fourth chip is connected with the third chip via a third photonic wire bond;
wherein the optical clock stabilizes two different wavelengths from 405 nm to 2350 nm to a desired optical frequency.

2. The optical clock of claim 1, wherein the microcomb PIC comprises a photonic-crystal resonator microcomb.

3. The optical clock of claim 2, wherein the photonic-crystal resonator microcomb comprises tantalum pentoxide and lithium niobate.

4. The optical clock of claim 3, wherein the photonic-crystal resonator microcomb integrates a thin film lithium niobate with a low-loss tantalum pentoxide waveguide.

5. The optical clock of claim 3, wherein the lithium niobate has a structure of periodically poled lithium niobate.

6. The optical clock of claim 1, wherein the optical reference PIC comprises a stress-optic modulator comprising an actuator and a ring resonator.

7. The optical clock of claim 6, wherein the actuator is laterally and vertically offset from a core of the ring resonator and from an optical mode profile of the ring resonator such that the actuator does not appreciably affect a waveguide loss or a resonator quality factor (Q).

8. The optical clock of claim 7, wherein the core of the ring resonator comprises a material selected from the group consisting of: silicon nitride, tantalum pentoxide, alumina oxide, and aluminum nitride.

9. The optical clock of claim 6, wherein the actuator comprises lead zirconate titanate (PZT) and the ring resonator comprises silicon nitride, and the modulator functions at a wavelength selected from the group consisting of: a visible wavelength range from 400 nm to 750 nm, a near IR wavelength range from 700 nm to 2500 nm, and a mid IR wavelength range from 2500 nm to 25,000 nm.

10. The optical clock of claim 6, wherein the actuator comprises PZT and the ring resonator comprises tantalum pentoxide, alumina oxide, or aluminum nitride, and the modulator functions at a wavelength range selected from the group consisting of: a far-UV wavelength range from 100 nm to 200 nm, a mid-UV wavelength range from 200 nm to 300 nm, a near UV wavelength range from 300 nm to 400 nm, and a visible, near IR and mid-IR wavelength range from 400 nm to 2350 nm.

11. The optical clock of claim 1, wherein the laser source comprises a semiconductor laser.

12. The optical clock of claim 11, wherein the semiconductor laser is an indium phosphide distributed-feedback laser.

13. The optical clock of claim 1, wherein the two different wavelengths are 780 nm and 1560 nm.

14. The optical clock of claim 1, wherein the first, second, third, and fourth photonic chips are deposited on a same substrate.

15. The optical clock of claim 1, wherein the optical clock is compatible with CMOS foundry fabrication process.
